(19) United States
(12) Patent Application Publication
(10) Pub. No.: US 2026/0121694 A1
(43) Pub. Date: Apr. 30, 2026

(54) RECONFIGURABLE INTELLIGENT SURFACE AND METHOD OF CONTROLLING RECONFIGURABLE INTELLIGENT SURFACE

(71) Applicant: Electronics and Telecommunications Research Institute, Daejeon (KR)

(72) Inventors: sung woo Choi, Daejeon (KR); Hee Sang Chung, Daejeon (KR)

(21) Appl. No.: 19/374,175

(22) Filed: Oct. 30, 2025

(30) Foreign Application Priority Data
Jul. 30, 2025 (KR) 10-2025-0103966
Oct. 30, 2024 (KR) 10-2024-0150885

(51) Int. Cl. H04B 7/04

(52) U.S. Cl. CPC H04B 7/04026

(57) ABSTRACT

A RIS includes an oscillator generating a clock, an optical module connected to a base station via an optical network, a plurality of RIS elements, and an RIS controller including a counter. The RIS controller receives a synchronization signal from the optical network and a control signal from the base station via the optical module, initializes the counter in accordance with the clock and the synchronization signal to be synchronized with the base station, when RIS beamforming information and RIS time information are acquired based on the control signal generates RIS element control information for beam direction control corresponding to the RIS beamforming information, calculates a control time point (Tc) in accordance with the RIS time information using the synchronized counter, and outputs the RIS element control information to the plurality of RIS elements at the Tc to be generate a beam in accordance with the RIS beamforming information.

### CROSS-REFERENCE TO RELATED APPLICATIONS

This application claims priority to and the benefit of Korean Patent Application No. 10-2024-0150885, filed on October 30, 2024, and Korean Patent Application No. 10-2025-0103966, filed on July 30, 2025, the disclosure of which is incorporated herein by reference in its entirety.

### BACKGROUND

### 1. Field of the Invention

Various exemplary embodiments disclosed in the present document relate to a reconfigurable intelligent surface (RIS) control technology.

### 2. Discussion of Related Art

5^{th} Generation (5G) mobile communications recommend the use of signals in the millimeter wave band above 24 GHz to support high data speeds. Also, according to 6^{th} Generation (6G) mobile communications, technologies that utilize sub-THz or THz frequencies are being developed to achieve higher data speed.

However, signals with frequencies of millimeter waves (generally 24 GHz and above) and higher-frequencies experience drastic attenuation in the atmosphere, thus weakening rapidly with distance. Due to their short wavelengths, the signals penetrate large obstacles and exhibit little reflection or diffraction (bend around obstacles). Therefore, signals with frequencies of millimeter waves and higher-frequencies may cause coverage holes where signals transmitted from base stations fail to reach terminals. These coverage holes are caused by buildings and other structures in outdoor environments, and are often caused by wall-like shielding inside buildings.

These days, reconfigurable intelligent surfaces (RISs) are gaining attention as a solution for expanding communication coverage with low investment costs. An RIS or intelligent reflecting surface (IRS) refers to a reconfigurable surface composed of metamaterials that exhibit artificial reflecting characteristics distinct from those of radio waves.

RISs is composed of two-dimensionally arranged metamaterials, and allows the reflection coefficient of the metamaterials forming the surface to be controlled. For example, adjusting the reflection coefficient of the metamaterial means that the phase and amplitude of a reflected wave may be changed. Here, changing the amplitude of a reflected wave requires a radio signal amplifier, which consumes significant power and increases the complexity of metamaterials. Therefore, passive RISs that employ passive elements to only adjust phase are frequently used. Passive RISs have simple structures, enabling development thereof at low costs, and consume low power, resulting in low maintenance expenses.

The reflection coefficient of these RIS metamaterials (RIS elements) may be controlled via a control ink from a base station managing a network. A communication path (link) for a base station to control operation of an RIS is called an RIS control link, and RIS control information is transmitted via the RIS control link. The RIS control link may be implemented wirelessly or by wire.

### SUMMARY OF THE INVENTION

A wireless reconfigurable intelligent surface (RIS) control link employs a method in which an RIS directly receives a control signal from a base station (direct reception method) or a method in which an RIS indirectly receives a control signal from a base station via a terminal communicating with the base station (terminal-connected reception method). For example, the direct reception method requires a function of communicating with a base station or receiving at least a base station signal and demodulating received data (a radio frequency (RF) reception hardware block, etc.) in an RIS. As another example, the terminal-connected reception method requires an interface (e.g., short-range communication, an unshielded twisted pair (UTP) cable, a serial cable) and a protocol to connect a communication terminal to an RIS. As such, according to the RIS direct reception method, a wireless RIS control link includes the function of a mobile communication terminal, complicating the RIS structure. Further, a wireless RIS control link further includes a reception RF module or an additional antenna and an RF module on a reflective RIS panel and also requires physical layer and upper-layer functionality of a terminal.

Further, in the case of controlling multiple RISs, a wireless RIS control method involves allocating wireless transmission resources (frequency and time). Accordingly, processing is further complicated, and a transmission error rate is higher than that of a wired RIS control method.

Meanwhile, the simplest form of an RIS is a reflective RIS, which may be designed to directly demodulate or transmit a received signal. The former type of RIS with a signal demodulation function (hereinafter “first RIS”) may be directly controlled via a wireless channel. However, the first RIS requires signal processing at the physical layer and the implementation of upper-layer protocol functions. Since the first RIS includes an RF receiver, hardware complexity and power consumption increase. The latter type of RIS that directly transmits a signal (hereinafter “second RIS”) also involves the implementation of the physical layer and upper layers and requires an RF transmitter. Further, in the case of connecting to a base station via an RIS or a wireless RIS control link with a function of demodulating or directly transmitting a received signal, hardware architecture and processing may become more complex.

Various embodiments disclosed in the present document may provide an RIS and RIS control method for simplifying hardware and control on the basis of a wired RIS control link.

According to an embodiment disclosed in the present document, there is provided an RIS including an oscillator configured to generate a clock, an optical module connected to a base station via an optical network, a reflective panel including a plurality of RIS elements, and an RIS controller including a counter. The RIS controller receives a synchronization signal from the optical network and a control signal from the base station via the optical module, initializes the counter in accordance with the clock and the synchronization signal to synchronize the counter with the base station, when RIS beamforming information and RIS time information are acquired on the basis of the control signal, generates RIS element control information for beam direction control corresponding to the RIS beamforming information, calculates a control time point in accordance with the RIS time information using the synchronized counter, and outputs the RIS element control information to the plurality of RIS elements at the calculated time point such that the plurality of RIS elements generate a beam in accordance with the RIS beamforming information.

According to an embodiment disclosed in the present document, there is provided an RIS including an oscillator configured to generate a clock, a Global Navigation Satellite System (GNSS) receiver configured to generate a pulse per second (PPS) signal, an optical module connected to a base station via an optical network, a reflective panel including a plurality of RIS elements, and an RIS controller including a counter. The RIS controller receives a control signal from the base station via the optical network and the optical module, initializes the counter in accordance with the clock and the PPS signal to synchronize the counter with the base station, when the RIS beamforming information and RIS time information are acquired on the basis of the control signal, generates RIS element control information for beam direction control corresponding to RIS beamforming information, calculates a control time point in accordance with the RIS time information using the synchronized counter, and outputs the RIS element control information to the plurality of RIS elements at the calculated time point such that the plurality of RIS elements generate a beam in accordance with the RIS beamforming information.

According to another embodiment disclosed in the present document, there is provided a method of controlling an RIS which includes an oscillator configured to generate a clock, an optical module connected to a base station via an optical network, a reflective panel including a plurality of RIS elements, and an RIS controller including a counter, the method including receiving a synchronization signal from the optical network and a control signal from the base station via the optical module, initializing the counter in accordance with the clock and the synchronization signal to synchronize the counter with the base station, when the RIS beamforming information and RIS time information are acquired on the basis of the control signal, generating RIS element control information for beam direction control corresponding to RIS beamforming information, calculating a control time point in accordance with the RIS time information using the synchronized counter, and outputting the RIS element control information to the plurality of RIS elements at the calculated time point such that the plurality of RIS elements generate a beam in accordance with the RIS beamforming information.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing a configuration of a mobile communication system employing a reconfigurable intelligent surface (RIS) according to an embodiment;

FIG. 2 is a diagram illustrating RIS control based on RIS control information;

FIG. 3 is a conceptual diagram of a wired RIS control link that connects a base station to a plurality of RISs via an optical cable;

FIG. 4 shows an example of a wired RIS control channel according to an embodiment;

FIG. 5 is a diagram of a synchronization signal according to an embodiment;

FIG. 6 is a diagram showing a configuration of an RIS according to an embodiment;

FIG. 7 is a flowchart of a method of controlling an RIS according to an embodiment;

FIG. 8 is a timing diagram of signals received or generated by an RIS according to an embodiment; and

FIG. 9 is a diagram showing a configuration of connections between a base station and a plurality of RISs according to an embodiment.

In relation to the description of drawings, like reference numerals may be used for like components.

### DETAILED DESCRIPTION OF EXEMPLARY EMBODIMENTS

A wired reconfigurable intelligent surface (RIS) control link receives an RIS control signal directly from a base station via a wired cable (wired connection) such as various optical cables, an unshielded twisted pair (UTP) cable, or the like.

Here, the wired RIS control link requires a wired connection from the base station to the RIS, resulting in drawbacks such as cable installation costs, maintenance expenses, and the like. However, when wired infrastructure such as an optical cable is provided around the RIS, a wired RIS control method is easily applicable.

Further, the wired RIS control method has the advantage of being available without allocating wireless transmission resources (frequency and time) even when controlling multiple RISs. Also, wired transmission has a lower transmission error rate than wireless reception methods, exhibiting high reliability of control signals.

Meanwhile, an RIS control link (also referred to as “control link” below) involves defining transmission rules (protocol) and an interface. For example, when there are a large number of RIS elements or the phase resolution of RIS elements is high, the reflection capability of the RIS improves, but the amount of RIS control information increases accordingly. As another example, RIS beams may be set at slot and symbol intervals or set differently for an uplink and downlink. In this case, the number of RIS control operations increases. Therefore, the RIS control link is to be designed to accommodate the volume of information, required time, and the structure and capabilities of the RIS, and is to enhance transmission reliability. In this regard, an RIS control link according to an embodiment is implemented as a wired interface, thus enhancing reliability of control signals.

In RIS-assisted mobile communication systems, accurately and efficiently controlling an RIS may be classified as a core technology that is very important for the overall performance of the communication system.

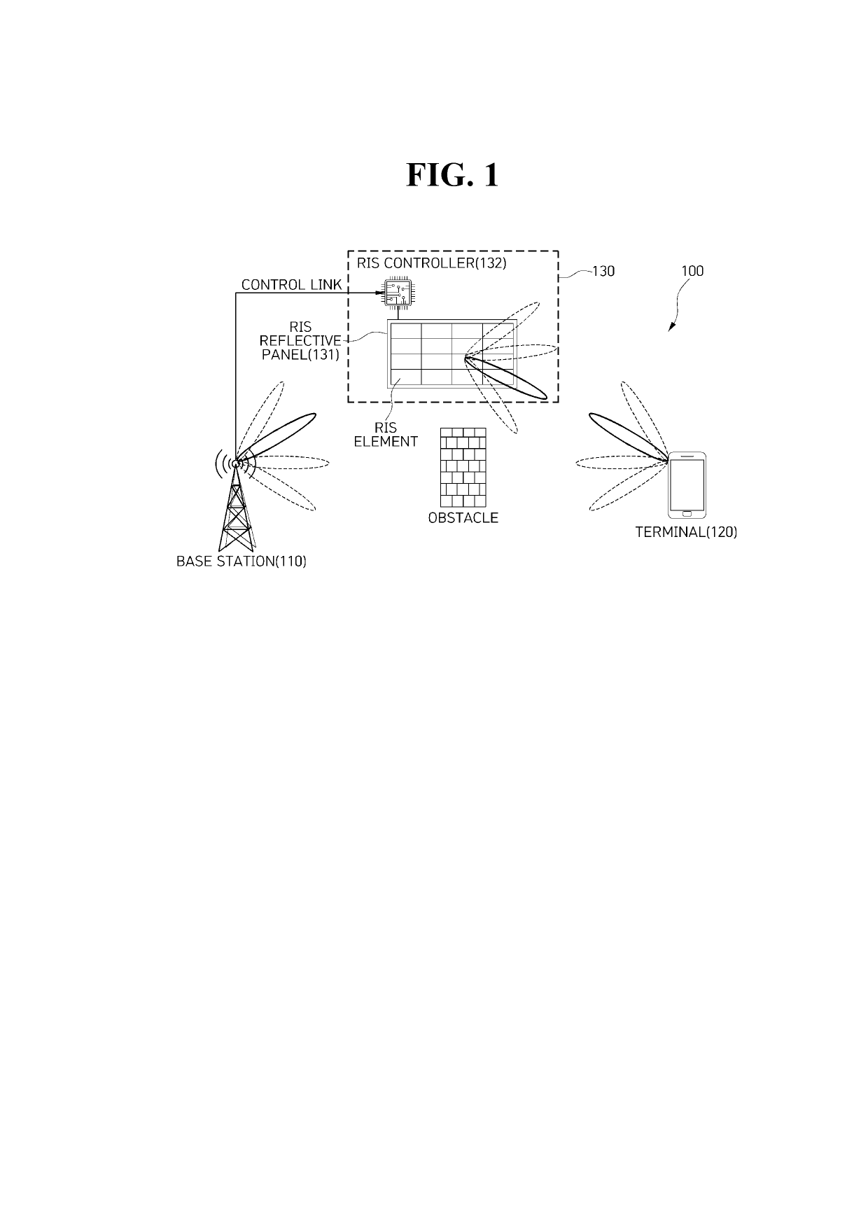

FIG. 1 is a diagram showing a configuration of a mobile communication system employing a RIS according to an embodiment. FIG. 1 is an example of a situation where a line of sight (LoS) environment is not established between a base station 110 and a terminal 120 due to an obstacle. Since wireless communication based on frequencies of millimeter waves or above is nearly impossible in the non-LoS situation, the base station and the terminal communicate with each other by utilizing a reflected wave from an RIS 130 as shown in FIG. 1 to find a new communication link.

The RIS 130 may adjust the direction of incident (or received) waves in accordance with control (RIS control information) of the base station 110. To this end, the RIS 130 includes a reflective RIS panel 131 composed of a plurality of RIS elements and an RIS controller 132.

The RIS controller 132 is connected to the RIS elements and controls a reflection coefficient of each RIS element in a timely manner. To this end, the RIS controller 132 receives RIS control information (time information and beamforming information) from the base station 110 via a control link. Generally, the RIS 130 does not direct all beams but selects and uses one of a plurality of predetermined beams. Accordingly, the RIS controller 132 generates RIS element control information on the basis of the RIS beamforming information such that all the RIS elements connected to the reflective RIS panel 131 may generate the selected beam. Then, the RIS controller 132 outputs the generated RIS element control information to the RIS elements in accordance with the RIS time information.

The RIS control link may be activated by the base station 110 or the terminal 120 and implemented using at least one of a wireless communication technology or a wired communication technology. A wireless control link may be based on wireless local area network (WLAN)/wireless personal area network (WPAN) technology, etc., such as 3^{rd} Generation Partnership Project (3GPP) 2^{nd} Generation (2G)/3^{rd} Generation (3G)/4^{th} Generation (4G)/5^{th} Generation (5G) mobile communication, Wi-Fi, and Bluetooth. Also, a wired control link may be based on optical transmission technology, local area network (LAN) technology supporting transmission control protocol (TCP)/Internet protocol (IP), and fronthaul technology connecting a base station to distributed antennas, and the like. Over the wired control link, RIS control information may be transmitted in the form of packets, for example, IP packets. In contrast, the wired control link may be changed to and used as a 3GPP Iuant interface. In this case, the Iuant interface is intended to adjust the tilt of a remote electrical tilt (RET) antenna and may be designed for, for example, 3-layer (application, datalink, and physical layers) based cable communication.

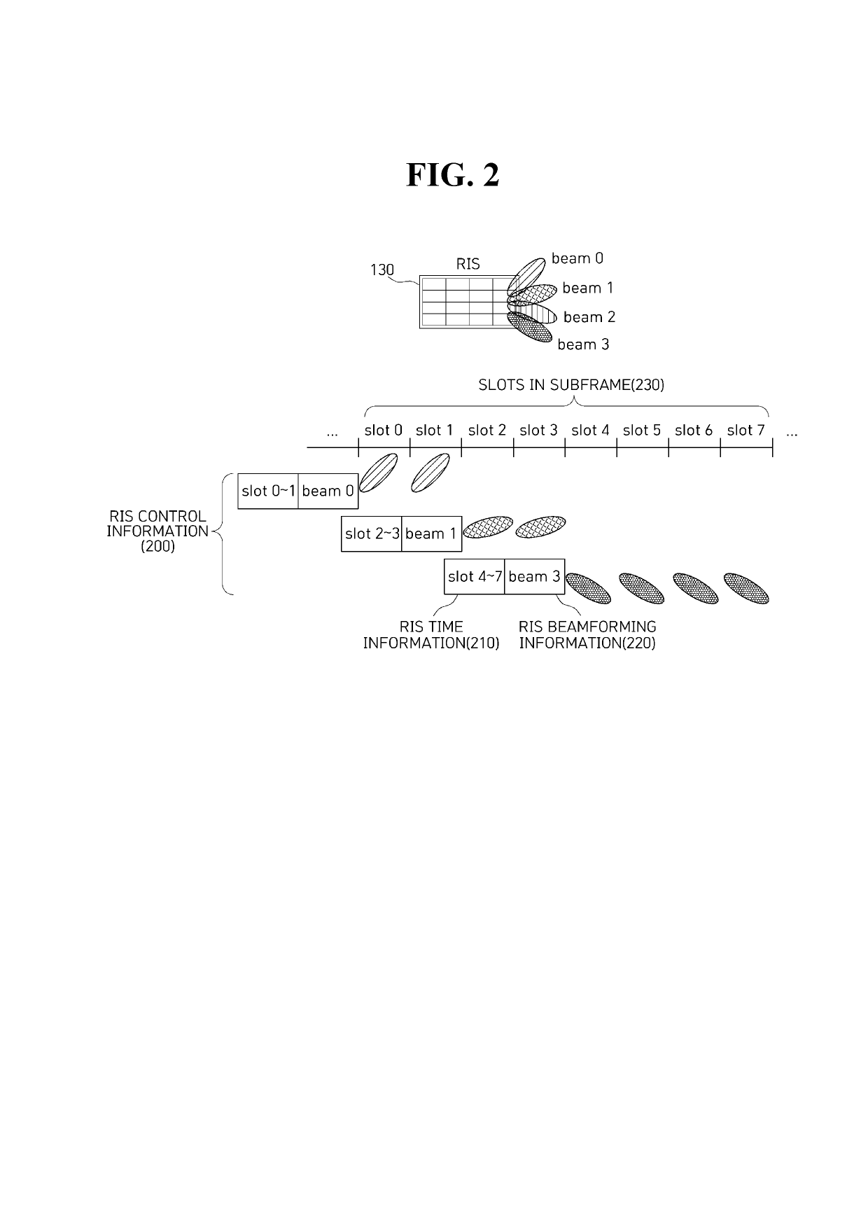

FIG. 2 is a diagram illustrating RIS control based on RIS control information. FIG. 2 illustrates an example where the RIS 130 may generate four reflected beams beam 0, beam 1, beam 2, and beam 3 corresponding to four directions using incident radio waves.

RIS control information 200 includes RIS time information 210 and RIS beamforming information 220. The RIS time information 210 is about a specific timeslot, symbol, etc., to which each RIS beamforming is applied. In other words, the RIS time information 210 indicates time resources (slot numbers in FIG. 2) with which reflected beams in accordance with the RIS beamforming information 220 are transmitted. The RIS beamforming information 220 indicates information on a selected one of a plurality of beams.

The RIS controller 132 receives the RIS control information 200 before a certain time from a time specified in the RIS time information 210. The RIS controller 132 decodes the received RIS control information 200 to acquire the RIS time information 210 and the beamforming information 220. The RIS controller 132 may output RIS element control information in accordance with beamforming information to the RIS elements at a time point corresponding to the RIS time information 210 to adjust reflection coefficients of the RIS elements. Accordingly, the RIS 130 may adjust beam directivity of radio waves incident on the RIS elements in the reflective RIS panel 131 from the base station 110.

The RIS controller 132 is connected to all the RIS elements and sends the RIS element control information to the RIS elements to adjust phases of the RIS elements. The RIS elements may have an n-bit input for adjusting their phases. n-bit information (or, n-bit input) may control 2ⁿ reflected phases. Phase-controlled reflected waves of the elements are combined to determine beamforming of an RIS antenna.

Meanwhile, the RIS control information is transmitted as a physical signal, and the generation and restoration of the signal are performed via a standardized channel (RIS control link). A channel in which control information of the RIS 130 is transmitted and received is an RIS control channel and has a similar purpose and forwarding method to those of a 3GPP downlink control channel (physical downlink control channel (PDCCH)) or uplink control channel (physical uplink control channel (PUCCH)).

As described above, RIS control links include wireless RIS control links and wired RIS control links.

First, wireless control links may be implemented using an RIS direct reception method and a terminal-connected reception method. To this end, an RIS (in the case of the RIS direct reception method) or an RIS control link reception terminal (in the case of the terminal-connected reception method) receives an RIS control channel signal sent by a base station. As a basic signal reception condition, the RIS or RIS control channel reception terminal is to be synchronized with the base station to receive an RIS control channel signal.

In RIS-supporting mobile communication systems based on mobile communication standards such as 3GPP 5G New Radio (NR) or 3GPP 4G Long Term Evolution (LTE), a method of receiving an RIS control channel via a wireless RIS control link is as follows.

1) An RIS controller performs a cell search for initial access. The cell search involves searching for a cell identifier (ID) of a base station, acquiring downlink synchronization, and acquiring system information required for cell access. Generally, a terminal receives a synchronization signal (SS) or a physical broadcast channel (PBCH) block (or an SS block (SSB)) sent by the base station. The terminal may synchronize time and frequency with the base station using a primary synchronization signal (PSS) and a secondary synchronization signal (SSS) and receive a cell ID of the base station. Then, the terminal acquires a master information block (MIB) which is key information for cell access, via a PBCH. When the MIB is received, the terminal is aware of information on a location of a system information block (SIB) and completes preparation for connecting to a cell by decoding the SIB.

2) When the terminal is a general terminal requiring uplink data transmission, the terminal performs uplink time synchronization through a random access process after the cell search and accesses the cell. On the other hand, when the terminal is dedicated to receiving RIS control channels, the terminal may omit the random access process.

3) The terminal needs to acquire information on RIS control channel resources. In other words, it is necessary to identify which time-frequency resources are used for transmitting a signal of the RIS control channel. For this, the terminal may acquire RIS control channel information using the SIB.

4) The terminal acquires RIS control information by demodulating the signal of the RIS control channel.

Meanwhile, to support RISs within existing mobile communication standards, wireless RIS control links require changes in the standards and additional protocols. For example, an SIB additionally requires intra-cell broadcast information depending on whether RISs are supported. Additionally, a wireless RIS control link requires allocation and management of radio resources to allocate an RIS control channel. The wireless RIS control channel may be transmitted using a sequence-based method of transmitting a predetermined sequence, such as a Zadoff-Chu sequence, or a PDCCH-based method of transmitting an RIS control channel in the same manner as an existing downlink control channel. An RIS controller based on a wireless RIS control link requires hardware and protocol software for allocating and managing frequency resources of an RIS control channel.

As described above, a wireless RIS control link involves high hardware and software complexity for the implementation and operation of an RIS control channel. Therefore, when it is possible to connect an RIS to a base station via wired communication such as an optical cable, a wired control link may be advantageous in implementation. An RIS is directly controlled by connecting the RIS to a base station using an optical cable which is already installed on most building rooftops and the ground, such that a wired RIS control link may be simply implemented to configure a mobile communication system utilizing an RIS according to an embodiment.

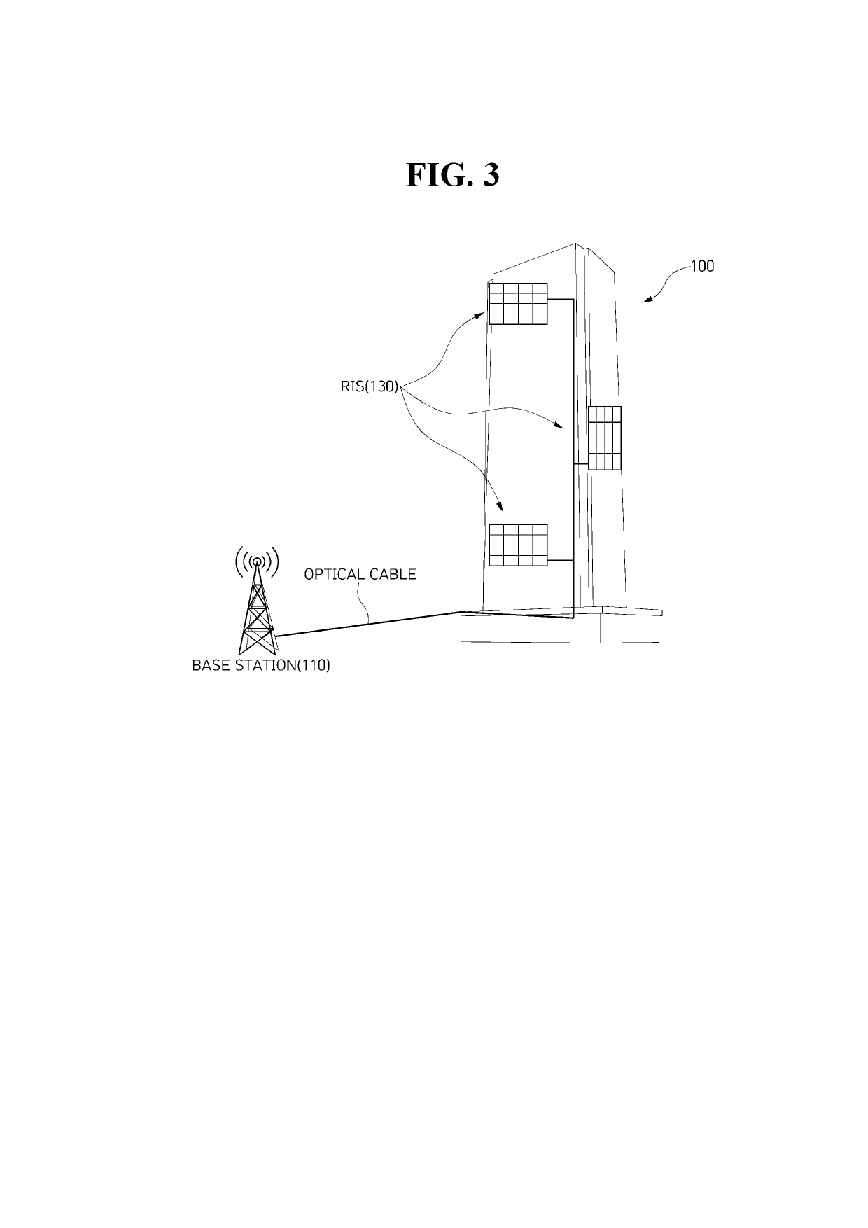

FIG. 3 shows an environment in which a wired RIS control link based on an optical cable between a base station and a plurality of RISs is implemented.

As shown in FIG. 3, a base station 110 and each of RISs 130 may be connected via a wired control link based on an optical cable laid in a building. In this case, since radio wave resources for an RIS control channel are not used, it may be efficient to utilize wireed network resources.

However, like in wireless RIS control, the wired RIS control link also requires synchronization between the base station 110 and the RISs 130. In wired networks, various technologies are used for synchronization between a base station and a cell depending on capabilities of equipment. For example, according to Institute of Electrical and Electronics Engineers (IEEE) 1588 referred to as precision time protocol (PTP), the times of nodes in a distributed system communicating over a network are synchronized. Another example is synchronous Ethernet (SyncE), which is an International Telecommunication Union Telecommunication standardization sector (ITU-T) standard technology for transmitting more precise timing. According to the technology, a clock for computer networking is transmitted using the Ethernet physical layer. However, PTP and SyncE require an additional clock server and a module with the function thereof, which hinders PTP and SyncE from being applied to distributed inexpensive devices such as RISs.

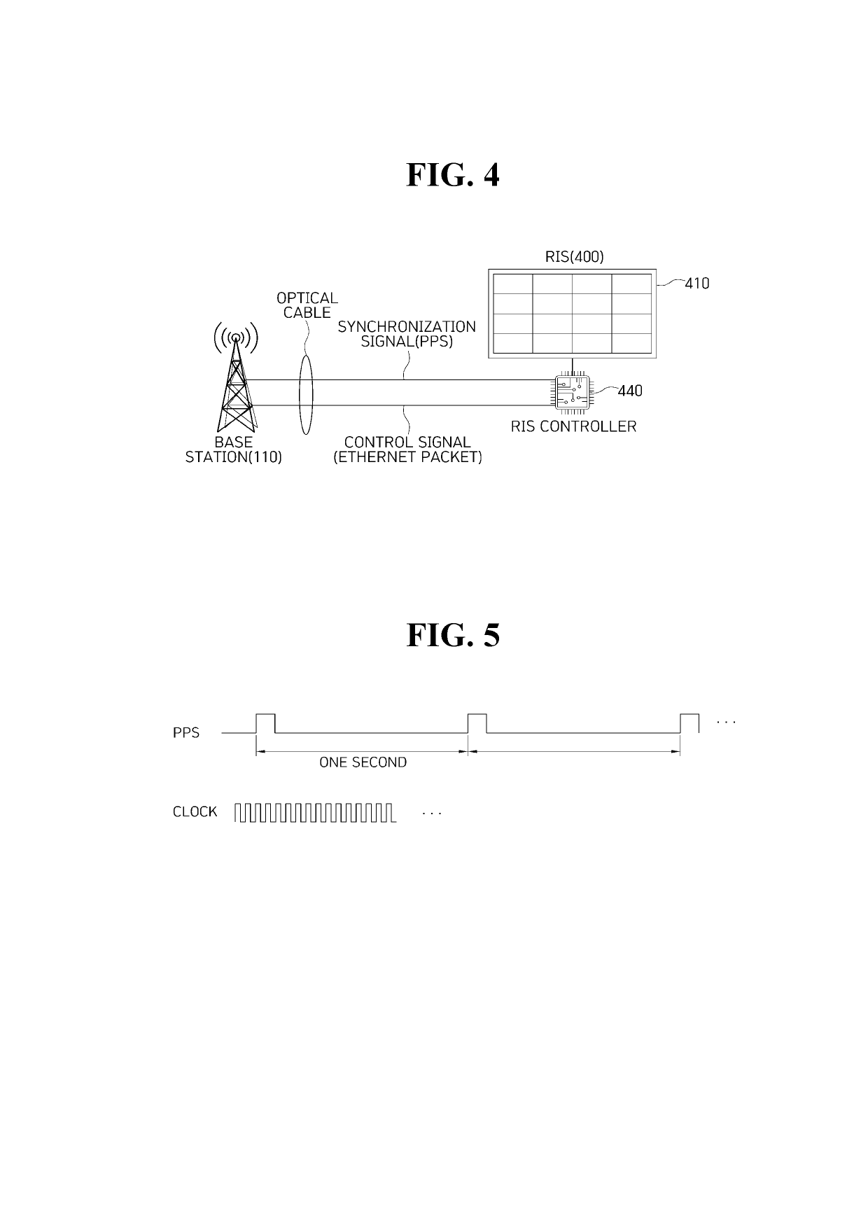

FIG. 4 shows an example of a wired RIS control channel according to an embodiment, and FIG. 5 is a diagram of a synchronization signal according to an embodiment.

Referring to FIG. 4, a base station 110 and an RIS 400 (the RIS 130 of FIG. 2) are connected via two optical cables. The first optical cable (hereinafter “synchronization line”) is for transmitting and receiving synchronization signals, and the second optical cable (hereinafter “control line”) is for transmitting and receiving control signal. At both ends of the optical cables in the base station 110 and the RIS 400, an optical module is provided to convert control signals between the base station and the RIS controller into optical transmission signals or convert optical transmission signals into control signals.

The base station 110 may transmit a PPS signal as a synchronization signal via the synchronization line. Referring to FIG. 5, the PPS signal is transmitted via the synchronization line at 1-second intervals.

The base station 110 may transmit an RIS control signal in the form of an Ethernet packet via the control line. Although only one RIS is shown in FIG. 4, the base station 110 may be connected to a plurality of RISs via the wired control link. However, the base station 110 and the RIS 400 may be connected in various forms including a one-to-one connection, a star topology, and a ring topology depending on the performance of the optical modules provided in the base station 110 and the RIS 400 and performance of an optical network.

In this way, in an RIS-supporting mobile communication system 100 according to an embodiment, it is possible to implement a wired RIS control link using optical cables that have been used, that is, the wired RIS control link can be easily implemented without new infrastructure.

Further, the RIS-supporting mobile communication system 100 according to the embodiment does not use radio wave resources, thus enabling higher network transmission efficiency than wireless RIS control links and improving the error rate of an RIS control channel. Consequently, it is possible to enhance the performance of the RIS-supporting mobile communication system.

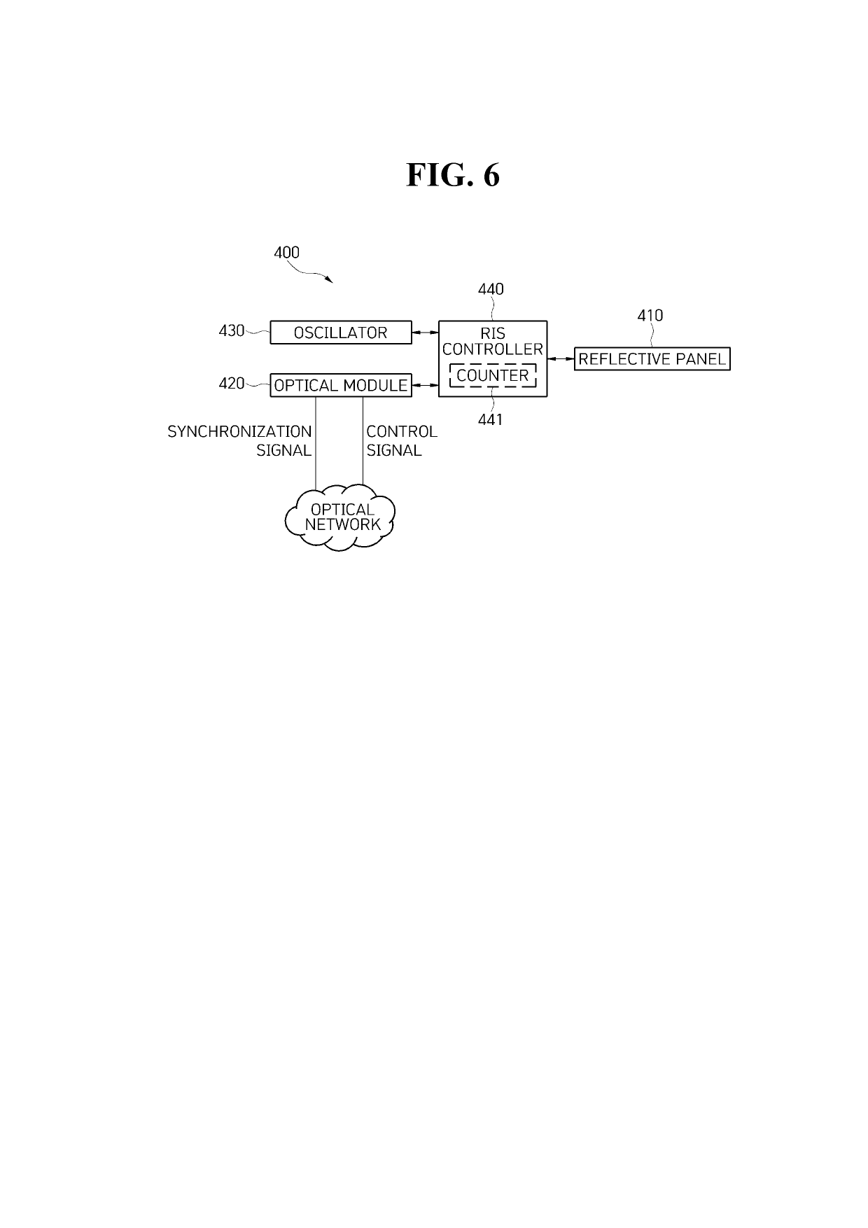

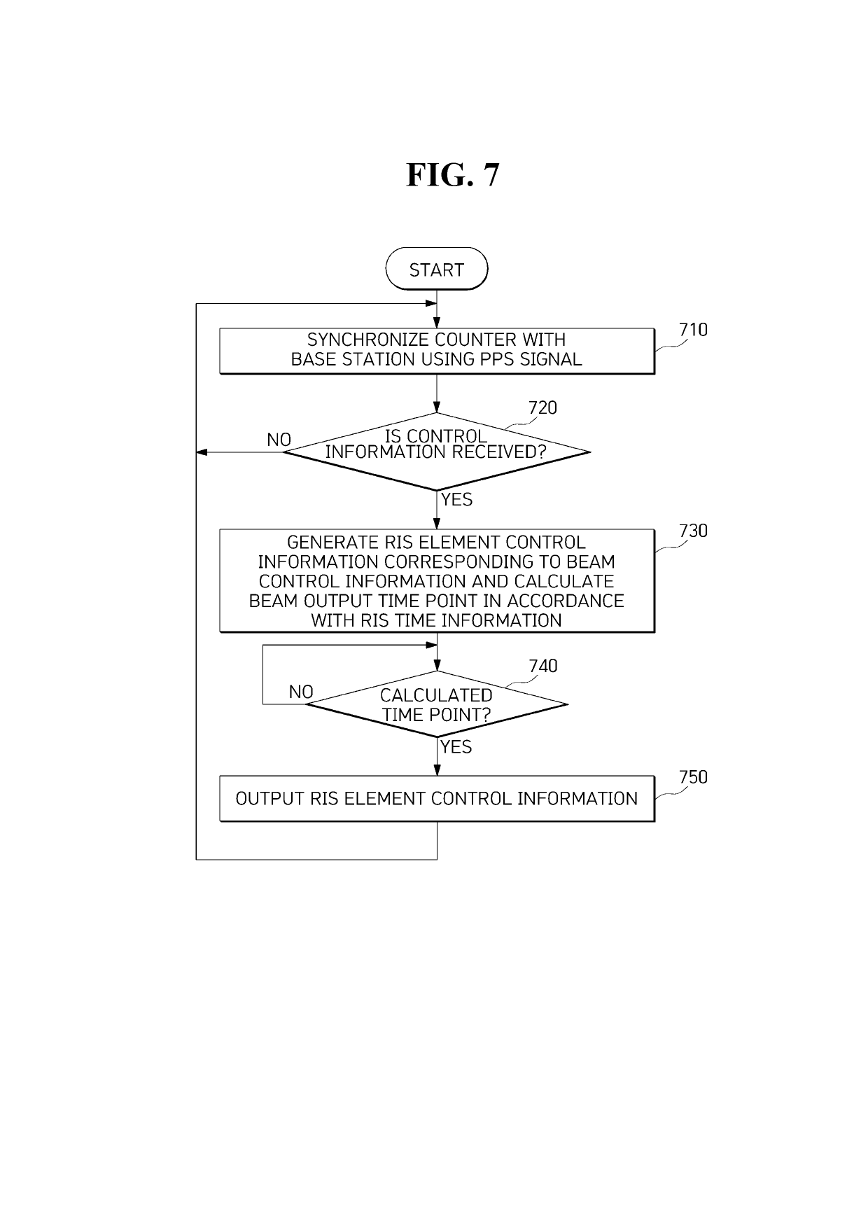

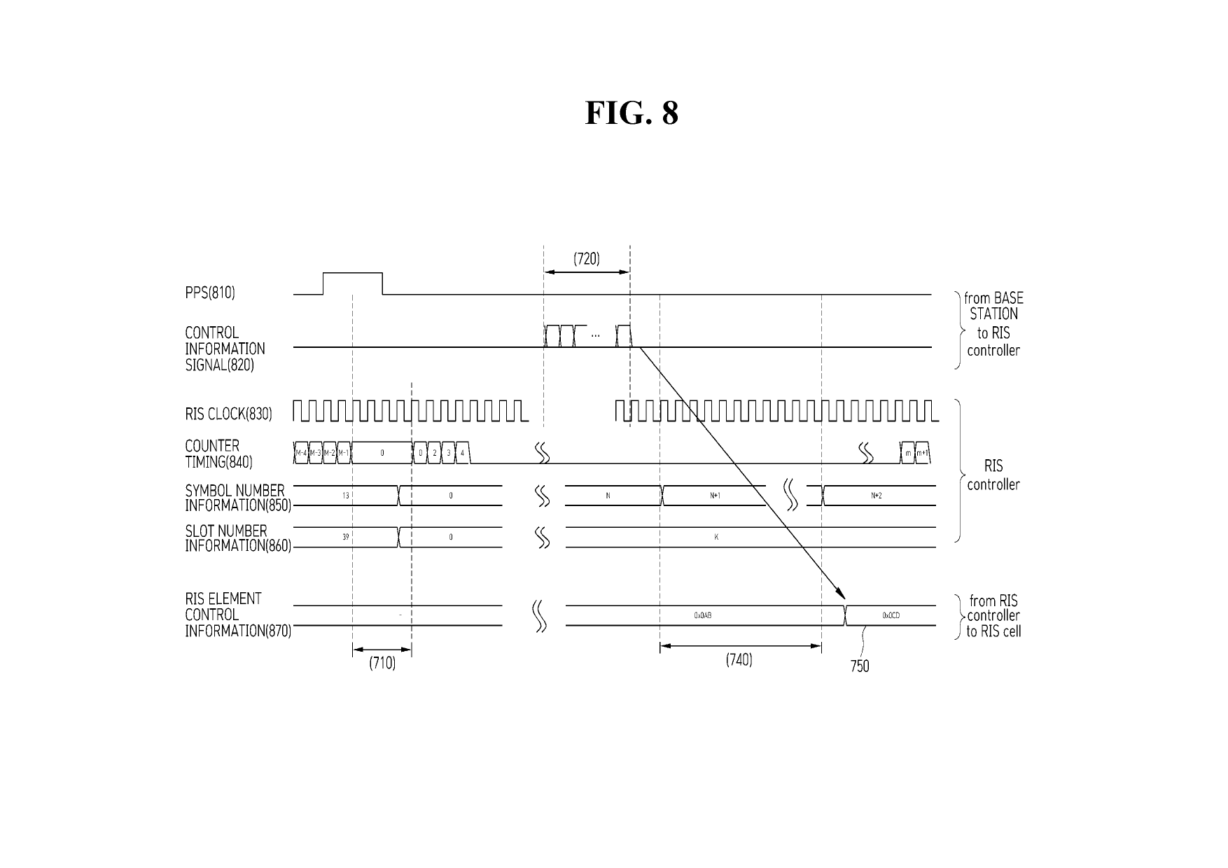

FIG. 6 is a diagram showing a configuration of an RIS according to an embodiment, and FIG. 7 is a flowchart of a method of controlling an RIS according to an embodiment. FIG. 8 is a timing diagram of signals in an RIS according to an embodiment.

Referring to FIG. 6, the RIS 400 (the RIS 130 of FIG. 2) may include a reflective panel 410 (e.g., the reflective RIS panel 131 of FIG. 1), an optical module 420, an oscillator 430, and an RIS controller 440 (the RIS controller 132 of FIG. 1).

The reflective panel 410 may include a plurality of RIS elements. Reflection coefficients of the RIS elements are adjusted in accordance with control of the RIS controller 440 such that the RIS elements may reflect radio waves incident from the base station 110 in accordance with beam directivity based on RIS control element information.

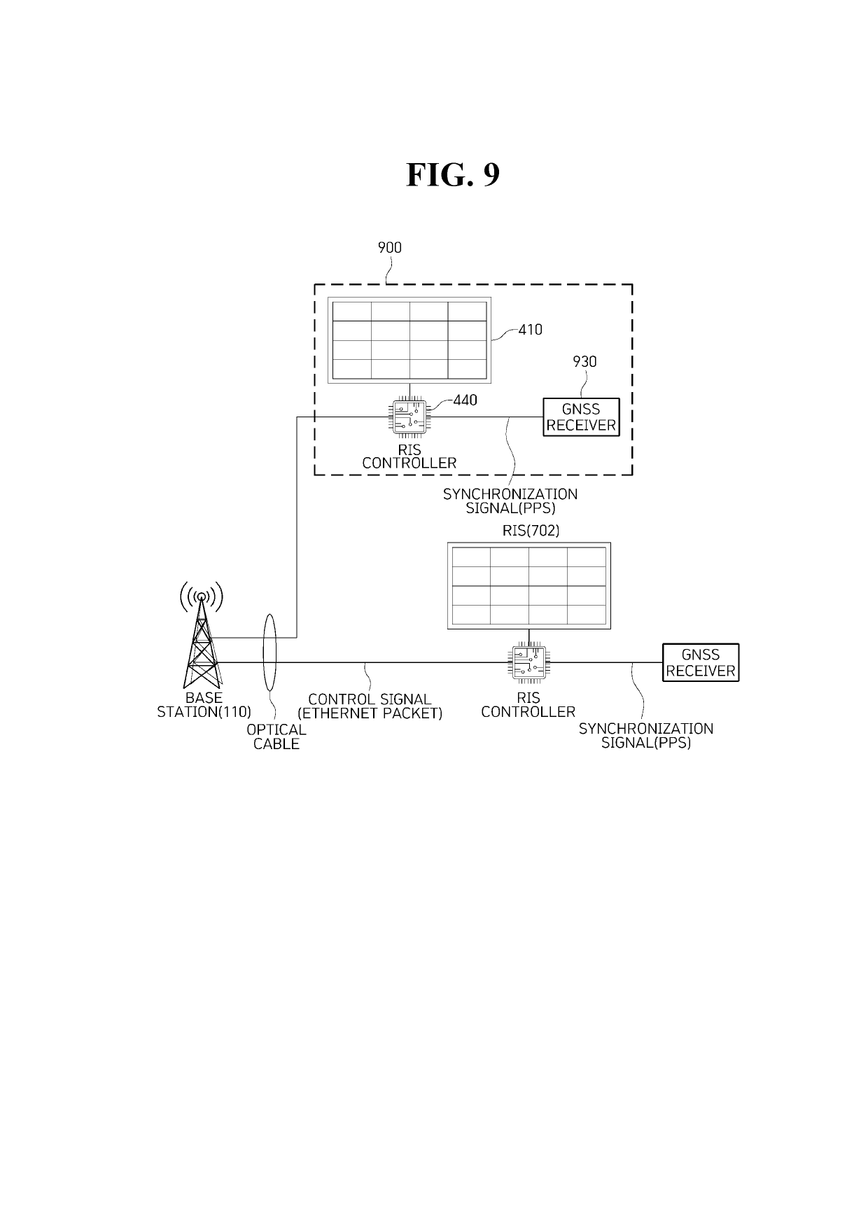

The optical module 420 may receive an optical transmission signal from an optical network, convert the received optical transmission signal into a control signal and a synchronization signal, and forward the converted signals to the RIS controller 440. For example, the optical module 420 may receive a first optical transmission signal including a control signal from the base station 110 and receive a second optical transmission signal including a synchronization signal from the base station 110 or a GNSS receiver (e.g., 930 of FIG. 9). In FIG. 6, an example in which the PSS is used as a synchronization signal is described. Errors of PPS signals are tens to hundreds of nanoseconds, which are shorter than microsecond-level errors of orthogonal frequency division multiplexing (OFDM) symbols. Accordingly, PPS signals are available for frame synchronization.

The oscillator 430 may include a high-precision and high-frequency oscillator and a phase loop lock (PLL). The oscillator 430 may generate a clock of a specified frequency synchronized with the synchronization signal by locking a PLL phase to the synchronization signal in accordance with control of the RIS controller 440.

The RIS controller 440 may control at least one other component (i.e., a hardware or software component) (e.g., the oscillator 430 and a counter 441) of the RIS 400 and perform various kinds of data processing or calculation. The RIS controller 440 may include at least one of, for example, a central processing unit (CPU), a microprocessor, an application-specific integrated circuit (ASIC), and a field programmable gate arrays (FPGA), and have a plurality of cores. The RIS controller 440 may include the counter 441 or control the separately provided counter 441. However, the present document illustrates an example where the RIS controller 440 includes the counter 441.

An RIS control method of the RIS controller 440 will be described below with reference to FIGS. 7 and 8.

Referring to FIG. 7, in operation 710, the RIS controller 440 may receive a synchronization signal (e.g., a PPS signal) 810 from the optical network via the optical module 420. When the synchronization signal is received, the RIS controller 440 may initialize the counter 441 in accordance with the synchronization signal and an RIS clock generated by the oscillator 430 (the counter 441 may be synchronized with a base station). Referring to FIG. 8, for example, the RIS controller 440 may acquire the synchronization signal 810 in accordance with a rising edge (or falling edge) of an RIS clock 830 and synchronize counting timing 840 of the counter 441 with the base station by initializing the counter 441 for a period corresponding to the synchronization signal 810 (e.g., for four clock cycles).

Subsequently, the RIS controller 440 may calculate a current OFDM symbol number and slot number on the basis of a value of the counter 441. For example, the RIS controller 440 may increment the symbol number by one when the value of the counter 441 is a multiple of 1024, and increment the slot number by one when the value of the counter 441 is a multiple of 1024*10.

In operation 720, the RIS controller 440 may receive a control signal (control information signal) 820 transmitted by the base station 110 from the optical network via the optical module 420. For example, referring to FIG. 8, the RIS controller 440 may receive the control signal 820 in accordance with a rising edge of the RIS clock 830.

In operation 730, the RIS controller 440 may acquire RIS time information and RIS beamforming information which are RIS control information by demodulating the received control signal 830. The RIS controller 440 may generate RIS element control information for beam direction control corresponding to the acquired RIS beamforming information on the basis of the RIS beamforming information. The RIS time information may include a slot number and a symbol number corresponding to a time point at which beamforming will be performed.

In operation 740, the RIS controller 440 may determine whether a time point corresponding to the RIS time information has arrived while varying and checking a slot number and a symbol number on the basis of the value of the counter 441. For example, according to the NR standard, when a subchannel bandwidth is 60 kHz, one subframe is composed of four slots, and the slots have a length of 0.25 ms. The time of one OFDM symbol is about 16.67 μsec. In other words, the RIS controller 440 may calculate a symbol number 850 and a slot number 860 corresponding to the RIS time information using the value of the synchronized counter 441.

In operation 750, the RIS controller 440 may output RIS element control information 870 to the plurality of RIS elements at a timing in accordance with the RIS time information.

Meanwhile, a synchronization signal (a PPS signal for synchronization) is transmitted every second, and when the PPS signal is received, the RIS controller 440 may reset the internal counter to 0.

In this way, in the RIS-supporting mobile communication system 100 according to the embodiment, it is possible to implement a wired RIS control link using optical cables that have been installed, that is, the wired RIS control link can be easily implemented without new infrastructure.

Further, the RIS-supporting mobile communication system 100 according to the embodiment does not use radio wave resources, thus enabling higher network transmission efficiency than wireless RIS control links and improving the error rate of an RIS control channel. Consequently, it is possible to enhance the performance of the RIS-supporting mobile communication system.

According to various embodiments, some components of the RIS 400 may be omitted, of additional components may be further included. Also, some components of the RIS 400 may be combined into one entity, which may perform the same functions as the corresponding components before the combination. FIG. 9 will be described below.

FIG. 9 is a diagram showing a configuration of connections between a base station and a plurality of RISs according to an embodiment.

Referring to FIG. 9, an RIS 900 may further include a GNSS receiver 930 in addition to the components of FIG. 6. In this case, an RIS 900 may generate a PPS signal (synchronization signal) using a GNSS receiver 930 (a Global Positioning System (GPS) receiver module) and may be synchronized with a base station 110 on the basis of the PPS signal. Also, the base station 110 may generate or receive the synchronization signal through the RIS 900 or a GNSS receiver thereof and may be synchronized with the RIS 900. As shown in FIG. 9, when the RIS 900 includes the GNSS receiver 930, the RIS 900 may provide the synchronization signal to other RISs via an optical module (420 of FIG. 6).

As described above, the RIS 900 may be implemented to receive a synchronization signal from the GNSS receiver 930 and receive an RIS control signal from the base station 110. FIG. 9 illustrates an example where each RISs (900, 702) receive synchronization signals from other GNSS receivers. However, embodiments of the present document are not limited thereto.

It is to be understood that various embodiments of the present document and terms used in the embodiments are not intended to limit technological features set forth herein to specific embodiments and include various modifications, equivalents, or substitutions for the embodiments. With regard to the description of the drawings, similar reference numerals may be used to refer to similar or related components. A singular form of a noun corresponding to an item may include one or more of the items unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C” may include any one of or all possible combinations of items enumerated together in a corresponding one of the phrases. Terms such as “1^{st}” and “2^{nd}” or “first” and “second” may be used to simply distinguish a corresponding component from another, and do not limit the components in other aspects (e.g., importance or order). When a (e.g., first) component is referred to, with or without the term “functionally” or “communicatively,” as “coupled” or “connected” to another (e.g., second) component, it means that the first component may be coupled to the second component directly (e.g., by wire), wirelessly, or via a third component.

As used herein, the term “module” may include a unit implemented in hardware, software, or firmware, and may be interchangeably used with other terms, for example, “logic,” “logic block,” “part,” or “circuitry.” A module may be a single integral component or a minimum unit or part thereof that performs one or more functions. For example, according to an embodiment, a module may be implemented in the form of an ASIC.

Various embodiments of the present document may be implemented as software (e.g., a program) including one or more instructions stored in a storage medium (e.g., an internal memory or an external memory) that is readable by a machine (e.g., an electronic device). For example, a processor (e.g., the RIS controller 440) of the machine (e.g., the RIS 400) may invoke at least one of the one or more instructions stored in the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not distinguish between a case where data is semi-permanently stored in the storage medium and a case where data is temporarily stored in the storage medium.

According to an exemplary embodiment, a method according to various embodiments disclosed in the present document may be included and provided in a computer program product. The computer program product may be traded as a product between a seller and a buyer. The computer program product may be distributed in the form of a machine-readable storage medium (e.g., a compact disc (CD) read-only memory (ROM)) or distributed (e.g., downloaded or uploaded) online via an application store (e.g., PlayStore^{TM}) or directly between two user devices (e.g., smartphones). When the computer program product is distributed online, at least a part of the computer program product may be temporarily generated or at least temporarily stored in the machine-readable storage medium, such as memory of the manufacturer’s server, a server of the application store, or a relay server.

Components according to various embodiments of the present document may be implemented in the form of hardware such as a digital signal processor (DSP), an FPGA, or an ASIC and perform certain roles. Components are not limited to software or hardware, and each component may be configured to reside in an addressable storage medium or run on one or more processors. As an example, components may include components such as software components, object-oriented software components, class components, and task components, processes, functions, attributes, procedures, subroutines, segments of program code, drivers, firmware, microcode, circuitry, data, databases, data structures, tables, arrays, and variables.

According to various embodiments, each of the above-described components (e.g., modules or programs) may include a single entity or a plurality of entities. According to various embodiments, one or more of the above-described components or operations may be omitted, or one or more other components or operations may be added. Alternatively or additionally, a plurality of components (e.g., modules or programs) may be integrated into a single component. In this case, the integrated component may still perform one or more functions of each of the plurality of components in the same or similar manner as they are performed by the corresponding one of the plurality of components before the integration. According to various embodiments, operations performed by a module, a program, or another component may be carried out sequentially, in parallel, repeatedly, or heuristically, at least one of the operations may be executed in a different order or omitted, or one or more other operations may be added.

According to various embodiments disclosed in the present document, it is possible to simplify hardware and control on the basis of a wired RIS control link. In addition, various effects that are directly or indirectly found in the present document can be provided.

What is claimed is:

1. A reconfigurable intelligent surface (RIS) comprising:
an oscillator configured to generate a clock;
an optical module connected to a base station via an optical network;
a reflective panel including a plurality of RIS elements; and
an RIS controller including a counter,
wherein the RIS controller receives a synchronization signal from the optical network and a control signal from the base station via the optical module, initializes the counter in accordance with the clock and the synchronization signal to synchronize the counter with the base station, when RIS beamforming information and RIS time information are acquired on the basis of the control signal, generates RIS element control information for beam direction control corresponding to the RIS beamforming information , calculates a control time point in accordance with the RIS time information using the synchronized counter, and outputs the RIS element control information to the plurality of RIS elements at the calculated time point such that the plurality of RIS elements generate a beam in accordance with the RIS beamforming information.

2. The RIS of claim 1, wherein the optical network comprises:
a synchronization line configured to receive a pulse per second (PPS) signal as the synchronization signal; and
a control line configured to receive the control signal in the form of an Ethernet packet.

3. The RIS of claim 2, wherein the synchronization line receives the PPS signal from the base station or an external Global Navigation Satellite System (GNSS) receiver.

4. The RIS of claim 1, wherein the RIS is connected to the base station in at least one form among a one-to-one connection, a star topology, and a ring topology depending on performance of the optical module and performance of the optical network.

5. A reconfigurable intelligent surface (RIS), comprising:
an oscillator configured to generate a clock;
a Global Navigation Satellite System (GNSS) receiver configured to generate a pulse per second (PPS) signal;
an optical module connected to a base station via an optical network;
a reflective panel including a plurality of RIS elements; and
an RIS controller including a counter,
wherein the RIS controller receives a control signal from the base station via the optical network and the optical module, initializes the counter in accordance with the clock and the PPS signal to synchronize the counter with the base station, when RIS beamforming information and RIS time information are acquired on the basis of the control signal, generates RIS element control information for beam direction control corresponding to the RIS beamforming information, calculates a control time point in accordance with the RIS time information using the synchronized counter, and outputs the RIS element control information to the plurality of RIS elements at the calculated time point such that the plurality of RIS elements generate a beam in accordance with the RIS beamforming information.

6. The RIS of claim 5, wherein the optical module forwards the PPS signal to at least one external RIS via the optical network.

7. The RIS of claim 5, wherein the optical network comprises:
a synchronization line configured to forward the PPS signal to at least one external RIS as a synchronization signal; and
a control line configured to receive the control signal in the form of an Ethernet packet.

8. The RIS of claim 5, wherein the RIS is connected to the base station in at least one form among a one-to-one connection, a star topology, and a ring topology depending on performance of the optical module and performance of the optical network.

9. A method of controlling a reconfigurable intelligent surface (RIS) including an oscillator configured to generate a clock, an optical module connected to a base station via an optical network, a reflective panel including a plurality of RIS elements, and an RIS controller including a counter, the method comprising:
receiving a synchronization signal from the optical network and a control signal from the base station via the optical module;
initializing the counter in accordance with the clock and the synchronization signal to synchronize the counter with the base station;
when RIS beamforming information and RIS time information are acquired on the basis of the control signal, generating RIS element control information for beam direction control corresponding to the RIS beamforming information;
calculating a control time point in accordance with the RIS time information using the synchronized counter; and
outputting the RIS element control information to the plurality of RIS elements at the calculated time point such that the plurality of RIS elements generate a beam in accordance with the RIS beamforming information.

10. The method of controlling RIS of claim 9, wherein the receiving of the synchronization signal comprises:
receiving a pulse per second (PPS) signal as a synchronization signal through a synchronization line of the optical network; and
receiving the control signal in the form of an Ethernet packet through a control line of the optical network.
